(19) United States
(12) Patent Application Publication
(10) Pub. No.: US 2019/0347651 A1
(43) Pub. Date: Nov. 14, 2019

(54) COMPUTER-IMPLEMENTED SYSTEM AND METHOD FOR TRANSFERRING MONEY FROM A SENDER TO A RECIPIENT

(71) Applicant: Mauricio Octavio Moreno, Miami, FL (US)

(72) Inventor: Mauricio Octavio Moreno, Miami, FL (US)

(21) Appl. No.: 15/978,104

(22) Filed: May 12, 2018

(51) Int. Cl. G06Q 20/36; H04L 9/06; G06Q 20/40

(52) U.S. Cl. CPC G06Q 20/3674; G06Q 20/4012; H04L 9/0637; G06Q 20/3678

(57) ABSTRACT

A system for transferring money includes an electronic communication device running an application for performing a number of tasks including enabling a sender to add a desired amount in a desired currency, provide necessary sender and receiver information including a contact information and unique ID of the receiver and create, encrypt and transfer a transaction information in form of blocks of a blockchain to a distributed blockchain network, having multiple computing nodes to store a portion of the blockchain. An electronic computing device associated with an authorized financial service provider, forming a computing node of the distributed blockchain network, allows to retrieve and decrypt the blocks containing the transaction information and verifies the unique ID and a unique PIN, which is generated by the application and sent to the receiver via the contact information given by the sender, submitted by the receiver for completing an instant cash transaction.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates generally to the field of money transfers, and in particular to a secure system and method for transferring money from a sender to a recipient using blockchain technology.

### Description of the related art

Present money transfer procedures typically involve an individual going to a money transfer location, such as a Western Union office, and giving the customer service representative a variety of personal information. This personal information may include the names and addresses of the sender and recipient, proof of identification, and the amount to be transferred. This information is entered into a money transfer system, and is used to create a record of the money transfer. After the money to be transferred has been collected from the sender, the sender notifies the recipient of the transfer. The recipient usually then goes to a separate money transfer location, such as another Western Union location, to pick up the money. The recipient may be required to provide a money transfer number and/or proof of identification, prior to picking up the money.

Also using another current technology, it is possible to transmit a payment to an ATM or similar financial terminal or kiosk for receipt only by its intended recipient. An example of this type of technology is the Z-CASH™ system developed by WESTERN UNION™. Terminals equipped with software to support the Z-Cash standard or format are capable of electronic money transfers to and from any equipped ATM or Western Union money transfer outlet. The Z-Cash system allows a consumer to electronically send money using any participating ATM by simply swiping an ATM card and selecting the money transfer option presented on the terminal's display device. The user is prompted to select a personalized code and the desired dollar amount to transfer. The sender relays the confirmation number and the personalized code to the intended recipient who can retrieve the finds from any participating ATM. No bankcard is required to retrieve the funds, just the confirmation number and personalization code, which provides a means for securing the transaction. An example of cardless transaction technology is presented in U.S. Pat. No. 6,045,039, entitled “Cardless Automated Teller Transactions”. One limitation of such systems is the lack of security against sophisticated hacking or other attacks, using which the hackers take control of the server for accessing the code or PIN or the ATM card or related information and impersonates as the recipient for receiving the cash transfer. There are several other prior arts for transferring money from a sender to a recipient, some of which are disclosed below for reference.

A prior art, U.S. Pat. No. 5,371,797 discloses a secure electronics funds or other financial transaction system that provides substantially equivalent security to that obtained by the use of secure point of sale terminals such as automatic teller machines, yet is conducted from unsecure terminal devices such as telephones. A customer registers himself or herself personally, together with information on his or her bank account at a secure transaction processor. A secure terminal is used to generate an encrypted version of a personal identification number (PIN) and provides the encrypted PIN and to the secure transaction processor. The encryption key used during encryption of the PIN is also acquired from either a specific request to, or monitoring data passing from a conventional network security transaction processor. The encrypted PIN is parsed with one portion being stored in the customer record at the secure transaction processor and the other being partially masked and provided back to the customer as an access code. Upon conducting a transaction, the customer provides the access code, which is unmasked and concatenated with second portion to recreate the original full encrypted PIN. This, together with the encryption key used for the original encryption is provided to conventional security and transaction processing apparatus for regional banking networks to seek authorization for the transaction.

Another prior art, U.S. Pat. No. 5,650,604 discloses a system and method for fully automated electronic transfer of cash or cash equivalent between a sender and a recipient, including an initiating terminal for receiving a designation of an amount of money to be electronically transferred, an account from which it is to be transferred, and a security code from the sender, a central terminal for storing the amount and the security code in a file in the central terminal, and a dispensing terminal for receiving from the recipient an entry corresponding to the designated amount of money to be transferred and the security code, for providing the entered amount of money and security code to the central terminal for comparison with the information stored in the central terminal's file, and for dispensing to the recipient funds equivalent to the designated amount of money without requiring the recipient to have a card to activate the dispensing terminal.

Yet another prior art, U.S. Pat. No. 6,554,184 discloses an Instant Money-Automatic Transfer Machine system. The system is a multiplicity of devices on a communications network available 24 hours a day, as sender, receiver and dispenser of finds interchangeably. The Aunty IM accepts standard currancy for deposit amounts or fees charged to transfer to another such receiver/dispenser device. The Sender starts a pending transaction transfer by indicating which device pays for the transfer (Sender, device A, or Dispenser, device B), to whom and where the funds are to be made available to device(s) B.sub.1-n. The amount is fed into currency acceptor at device A and a receipt is generated by the Sender, device A. A Receiver becomes a Dispenser only when the Receiver retrieves the pending transaction from device A using a verifiable password or identification. The cash is dispensed. The fee is charged at either end of the transaction.

All the above systems and methods provides insecure means for transferring money from one person to another as the information transferred over the network may get compromised. Hence there exists a need for a secure system and method for making instant cash transactions between a sender and a recipient.

### BRIEF SUMMARY OF THE INVENTION

In view of the foregoing disadvantages inherent in the known types of systems like in the prior arts, the present invention provides a computer-implemented system for transferring money from a sender to a recipient. The system includes an electronic communication device having at least one memory unit for storing instructions of an application and at least one processor for processing the instructions of the application to perform a number of tasks including enabling the sender to add a desired amount in a desired currency utilizing an interactive graphical user interface of the application, provide a variety of receiver information including at least one contact information and a unique identification information of the receiver to perform a secure transaction and encrypt and transfer a transaction information related to the secure transaction stored in form of at least one block of a blockchain. The transaction information includes the sender information, the receiver information including the unique identification information of the receiver, an encrypted code corresponding to the unique PIN generated by the application for the secure transaction and an information related to the desired amount selected by the sender. The system further includes a distributed blockchain network having a number of computing nodes, each computing node storing a copy or at least a portion thereof of the blockchain containing the transaction information related to the secure transaction performed by the sender. A secure wireless communication channel enabling communication between the electronic communication device and the computing nodes of the distributed blockchain network transfers the transaction information. The receivers can approach an authorized financial service provider for verifying the receiver information including a unique PIN generated by the application, received through the contact information of the provided by the sender for performing the secure transaction via the secure wireless communication channel. An application running on the electronic computing device associated with the authorized financial service provider communicates with the distributed blockchain network to retrieve and decrypt the at least one block containing the transaction information from the blockchain and verifies the unique identification information and the unique PIN submitted by the receiver for completing an instant cash transaction.

The present invention further relates to a computer-assisted method for transferring money from a sender to a recipient. The method includes the steps of providing the electronic communication device running the application to perform a number of tasks including enabling the sender to provide a variety of information including the sender information, receiver information and a desired amount in a desired currency through the interactive graphical user interface of the application, encrypting a transaction information including the information received from the sender, storing the transaction information in form of at least one block of a blockchain, transferring the transaction information using a distributed blockchain network having multiple computing nodes, each computing node storing a copy or at least a portion of the blockchain containing the transaction information and utilizing a secure wireless communication channel enabling communication between the electronic communication device and the computing nodes of the distributed blockchain network for transferring the transaction information. The receiver receives the information including a unique PIN generated by the application for performing a secure transaction, through the at least one email address provided by the sender. The receiver can approach the authorized financial service provider having an application for verifying the receiver information. The electronic computing device of the authorized financial service provider forms the at least one computing node of the distributed blockchain network for retrieving the at least one block of the blockchain containing the transaction information in an encrypted form. The application running on the electronic computing device of the authorized financial service provider decrypts the transaction information from the blockchain for verifying the receiver information including the unique identification information of the receiver and the unique PIN generated by the application for the secure transaction. Upon successful authentication, the receiver receives an equivalent amount of the desired amount sent by the sender after deducting a preset service fee for the instant cash transaction set by the authorized financial service provider.

This above Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a block diagram of the present system for transferring money from a sender to a recipient utilizing blockchain technology, according to a preferred embodiment of the present invention.

FIG. 2 is a block diagram showing the different components and modules of the electronic communication device running the application for transferring money from a sender to a recipient utilizing blockchain technology, according to a preferred embodiment of the present invention.

FIG. 3 illustrates a block diagram showing the steps of creation of the blocks having the transaction information and forming the blockchain for transferring to a distributed blockchain network over a secure communication channel, according to an embodiment of the present invention.

FIG. 4 illustrates a flowchart showing the steps associated with the present method for sending money utilizing the present application for transferring money from the sender to a recipient using blockchain technology, according to a preferred embodiment of the present invention.

FIG. 5 illustrates a flowchart showing the steps associated with the present method for receiving the money, which is sent by the sender utilizing the present application using blockchain technology, from the authorized financial service provider, according to a preferred embodiment of the present invention.

FIG. 6 to FIG. 8 shows exemplary user interfaces of the present application, running on the electronic communication device, for transferring money from a sender to a recipient using blockchain technology, according to an exemplary embodiment of the present invention.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Glossary of Terms

As used herein, a “computer system” or “system” or “computer assisted system” or “computer implemented system” may refer to a networked system having one or more computers and/or other electronic devices, where each computer/electronic device may include computer-readable medium embodying software to operate the computer/electronic device or one or more of its components. Non-limiting examples of a computer system may include: a distributed computer system for processing information via computer systems linked by a network; and, two or more computer systems connected together via a network for transmitting and/or receiving information between the computer systems.

As used herein, the term “processor” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable medium” or “storage media” or “memory unit” or “non-transitory computer-readable media” refers to any medium that participates in providing data, for example, instructions, which may be read by a computer, an electronic device, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G etc.

As used herein, the term “Application” and/or “Software” refer to all, or a portion, of a computer program or software code that carries out a specific function and may be used alone or combined with other programs. It comprises computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software.

Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript., JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Electronic Computing Device” or “Electronic Communication Device” or “Electronic Device” refers to device comprising at least one processor, a graphical interface user, such as a smartphone, laptop, desktop, tablet, wearable smart device, etc., as well as any device defined herein as a “computer”.

As used herein, the term “Graphical User Interface” or “Dynamic Graphical User Interface” or “Interactive Graphical User Interface” refers to all the visually identifiable and/or intractable visuals displayed through a display of the electronic computing device.

A “browser” as used herein is not intended to refer to any specific browser, for example, Internet Explorer, Safari, Firefox, or the like, but should be broadly construed to refer to any client-side rendering engine that can access and display Internet-accessible resources. A “rich” client typically refers to a non-HTTP based client-side application, such as an SSH or CFIS client. The client-server interactions may occur using HTTP or other protocols. The client server interaction may be formatted to conform to the Simple Object Access Protocol (SOAP) and travel over HTTP or any other transport mechanism, such as CORBA, for transport over an enterprise intranet, may be used. Any application or functionality described herein may be implemented as native code, by providing hooks into another application, by facilitating use of the mechanism as a plug-in, by linking to the mechanism, and the like.

As used herein, the term “network” or “communication networks” or “communication channel” may operate with any of a number of protocols, wireless, WiFi, and such as Internet protocol (IP), asynchronous transfer mode (ATM), and/or synchronous optical network (SONET), user datagram protocol (UDP), IEEE 802.x.

Further, the term “authorized financial service provider” or “financial services provider” refers to a bank or a financial outlet like western union outlets, or similar money transferring outlets that allows people to either send or receive money instantly or through a bank account. In some instances, the “authorized financial service provider” or “financial services provider” refers to an instant cash transfer outlet that allows the customers to send and receive money instantly, even without a bank account, using the present system.

The following section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The present invention relates to a computer-implemented system and associated method for transferring money from a sender to a recipient utilizing blockchain technology, according to a preferred embodiment of the present invention. The present system and method forms a blockchain based identity verification and transaction platform that allows the users to transfer the identity and transaction information, which is made available in form of a block forming a part of the blockchain of information, over a distributed blockchain network having a number of computing nodes including the electronic communication devices at the sender's and the receiver's end, according to one or more embodiment of the present invention. The senders performing the cash transaction are allowed to transfer a desired amount in a desired currency from anywhere in the world to a receiver at any location. The senders can also provide the receiver's information such as unique identity information of the receiver, which is encrypted and transferred as blocks of the blockchain transferred over the distributed blockchain network. The receivers can approach any authorized financial service provider associated with the present system and provide the unique identity information of the receiver along with a unique PIN, which is received by the receiver through a communication mode, such as email, selected by the sender during the transfer. The present system performs the data retrieval, decryption and comparison of the information provided by the sender and the receiver to verify the authenticity of the receiver. Once authorized, the receiver receives an amount equivalent to the amount sent by the sender in form of instant cash transaction. In some instances, a flat rate based or transaction amount based service fee is charged, which is deducted from the amount transferred to the receiver. The present system and method is different from the conventional approach in which the senders and the receivers information is stored in centralized servers with conventional firewall and other data protection means. Such conventional systems are always prone to sophisticated data breaches and hacks and makes the conventional money transaction systems insecure. The present system and method, based on the blockchain technology based identity and transaction data transfer and data verification, provides secure storage of the encrypted transaction information including the information related to the senders, receivers and the transaction in a distributed computing environment involving a network of computers connected over a secure network. Thus the present system and method provides a secure platform for making instant cash transactions.

Before describing the features of the present invention, certain technical terms used in the present invention such as “blockchain” is described in detail below. As used herein, “blockchain” refers to a distributed storage platform and network in which individual “blocks” are connected in a chain. Each block is linked to the previous block in the blockchain by, for example, including a hash of the previous block as a “proof of work.” Various hash functions, including functions in the Secure Hash Algorithm (SHA)-1 or -2 families, such as SHA-256, can be used to perform a one-way hash. For a one-way hash, it is generally considered to be impossible or impractical to generate the input, i.e. the “message”, to the hash function based on the output i.e. the “message digest” or “digest”, of the hash function.

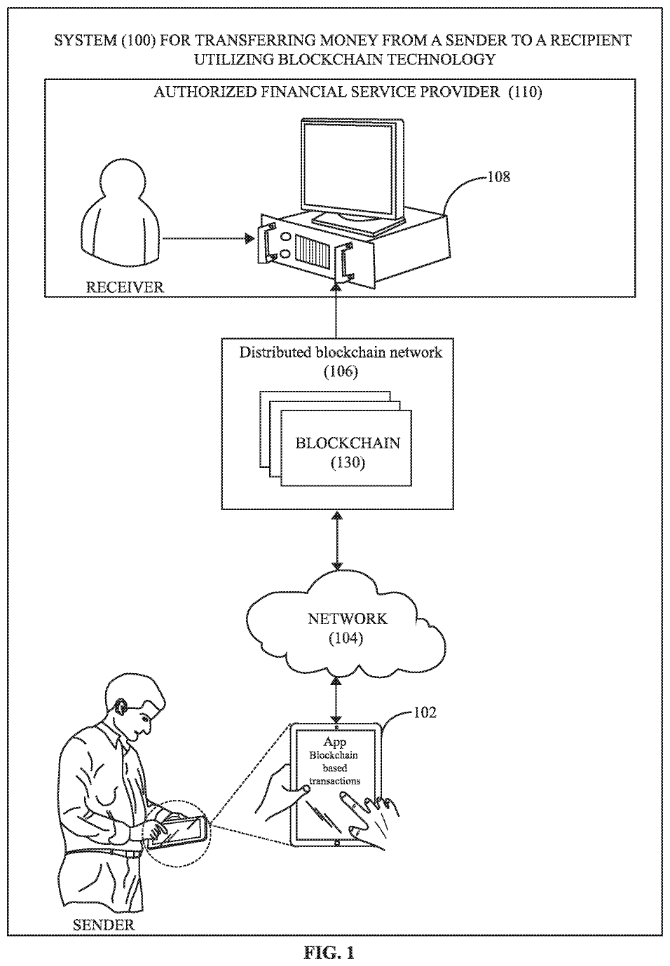

FIG. 1 illustrates a block diagram of the present system 100 for transferring money from a sender to a recipient utilizing blockchain technology, according to a preferred embodiment of the present invention. In a blockchain 130, the individual blocks can store a variety of data that may or may not be related i.e. the data may or may not be associated with a same user. The present system 100 includes an electronic communication device 102 having a memory unit for storing a number of instructions of an application for assisting the users to transfer money utilizing the blockchain technology. The instructions of the application, when executed using the processor of the electronic communication device 102 enables the users to perform a variety of tasks including select a desired amount in a desired currency through an interactive graphical user interface of the application for transferring to a receiver, provide a variety of sender and receiver information for performing the secure transfer utilizing the blockchain technology and perform automated encryption and transfer of the selected amount along with the other transaction related information, which are stored in form of one or more blocks in the blockchain 130, through a distributed blockchain network 106 having a large number of computing nodes, such as computers.

In the present system 100 for transferring money from a sender to a recipient utilizing blockchain technology, the electronic computing devices 102 are in communication with the distributed blockchain network 106 over a secure wireless communication channel or a network 104. The secure wireless communication channel or the network 104 can be the Internet, a Local Area Network (LAN), a Wireless Local Area Network (WLAN), a Wide Area Network (WAN), or other type of network, wired or wireless. The distributed blockchain network 106 can be, for example, one or more server computers, personal computers and other computers connected over the secure wireless communication channel or the network 104 to form the blockchain network. The present system 100 for transferring money from a sender to a recipient utilizing blockchain technology also include one or more computing devices or electronic computing devices 108, such as desktop computers, provided at one or more authorized financial service providers 110, in communication with the distributed blockchain network 106 over the wireless communication channel or the network 104. The electronic computing devices 108 runs an application for enabling communication with the distributed blockchain network 106 to retrieve and decrypt the block containing the transaction information from the blockchain 130 transferred over the distributed blockchain network 106 and verify the receiver for completing an instant cash transaction.

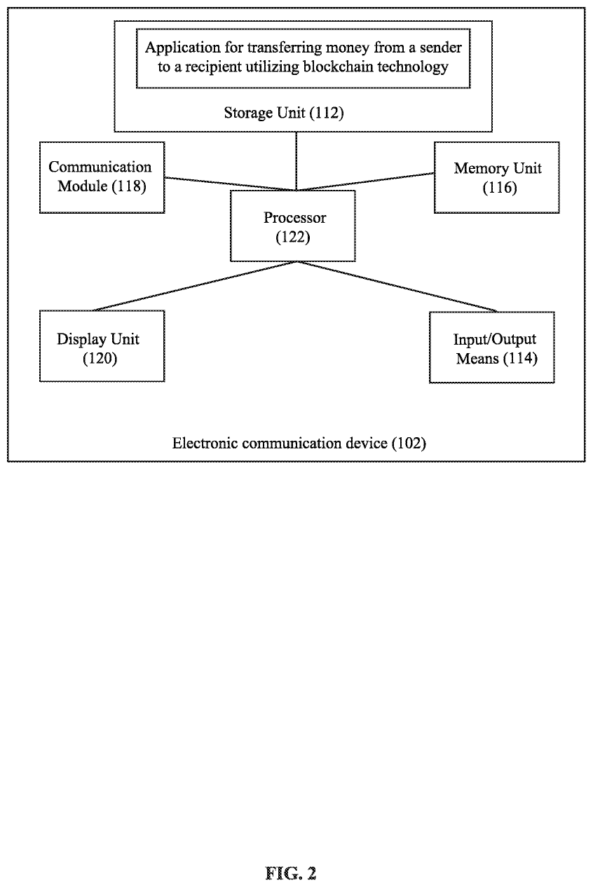

FIG. 2 is a block diagram showing the different components and modules of the electronic communication device 102 running the application for transferring money from a sender to a recipient utilizing blockchain technology, according to a preferred embodiment of the present invention. The electronic communication device 102 can be any smart device such as, but not limited to, a smartphone, tablet, computer, smart wearable devices, and other smart devices or a computer connected to the Internet and capable of displaying an interactive graphical user interface (GUI) of the application for assisting the users to instantly transfer money to a recipient through secure channel utilizing blockchain technology. The electronic communication device 102 includes a processor 122 to process a number of instructions of the application, which enable the sender to perform a variety of tasks such as to add a desired amount in a desired currency, utilizing the interactive graphical user interface of the application, for making an instant cash transfer to a receiver, provide the sender and receiver information including one or more email address and a unique identification information of the receiver to perform a secure transaction and encrypt and transfer a transaction information related to the secure transaction stored in form of a block of a blockchain 130 through the distributed blockchain network 106. The electronic communication device 102 further includes a display unit 120 for displaying the interactive graphical user interface of the application, a storage unit 112 for storing a variety of data, an input/output means 114 for connecting external devices, a memory unit 116 for temporarily storing the data and instructions while performing a number of operations by the processor 122 based on the instructions of the application capable of being executable by the processor 122 to perform the above said tasks and a communication module 118 to enable communication between the electronic communication devices 102 and the distributed blockchain network 106 via the secure wireless communication channel or the network 104. The users are allowed to interact with the contents presented on the interactive graphical user interface of the application using a keyboard, pointing device such as a mouse, at least one gesture or touch, voice activation, or any other interacting means.

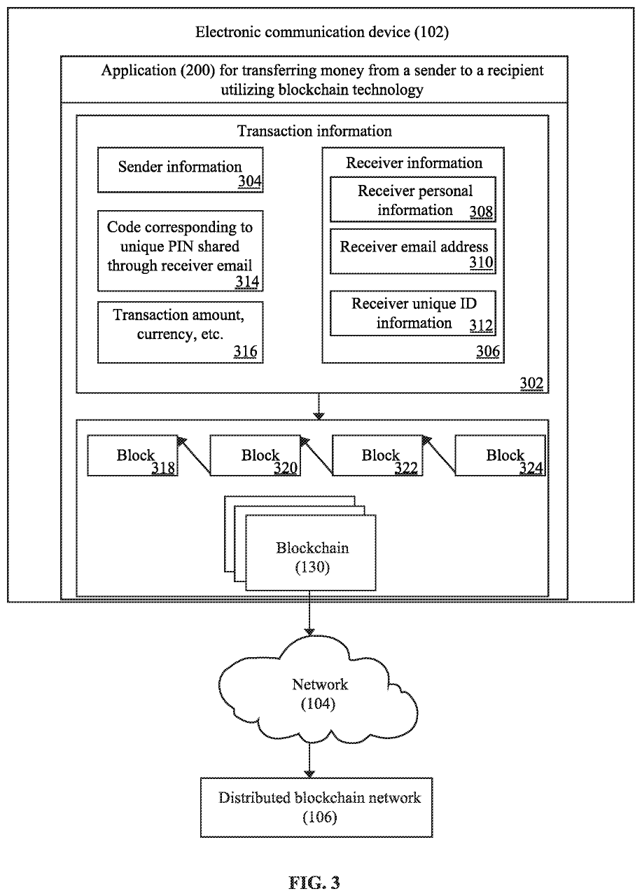

FIG. 3 illustrates a block diagram showing the steps of creation of the blocks, having the transaction information, and forming the blockchain 130, which is transferred to the distributed blockchain network 106 over the secure communication channel or the network 104, according to an embodiment of the present invention. The present application 200, for transferring money from a sender to a recipient utilizing blockchain technology, launched from the electronic communication device 102, such as a smartphone or tablet or personal computer, of the sender enables them to select a desired amount for transferring to a receiver. The sender is also prompted to provide a variety of transaction information through the interactive graphical user interface of the application 200, as in block 302. The transaction information collected by the application 200, from the sender, includes the sender information such as the personal information including name, Email address and other information related to the sender, as in block 304. In some instance, the application 200 automatically collects the sender information from the user profile of the application 200. Further, the sender is prompted to provide the receiver information through the interactive graphical user interface of the application 200, as in block 306. The receiver information includes the receiver personal information including the name and the address of the receiver as in block 308, receiver email address as in block 310, and unique ID information of the receiver as in block 312. For every transaction, the present application 200 automatically generates a unique PIN and shares the PIN to the receiver via the email of the receiver, provided to the application 200 by the sender, as in block 310. In some instances, the present application 200 also allows the senders to provide one or more contact means such as email or phone number or other contact means to share the secret unique PIN for the particular transaction with the receiver. The transaction information generated by the present application 200 further includes a code corresponding to the unique PIN shared to the receiver via the email or any other contacting means of the receiver, which is provided by the sender through the graphical user interface of the application 200, as in block 314. Next the transaction information includes the transaction details such as the amount, currency, as in block 316. The transaction information is a collection of all the above information, which is further encrypted by the application 200 and forms one or more blocks 318 to 324 of the blockchain 130. In some instances, the transaction information is stored in a single block 318, which forms part of the blockchain 130. The blockchain 130 having the number of blocks 318 to 324 is then transferred to the distributed blockchain network 106 over the secure communication channel or the network 104.

The receiver receives the email with the unique PIN number for making the instant cash transaction from any authorized financial service provider 110 through the blockchain based data transfer and authentication method associated with the present system 100. The receiver can submit the unique PIN number and the unique ID of the receiver to the authorized financial service provider 110. The authorized financial service provider 110 authenticates the transaction and the authenticity of the receiver utilizing the application 200 launched from their electronic communication or electronic computing device 108 such as the office computer. In some instances, the authorized financial service provider 110 authenticates the transaction and the authenticity of the receiver utilizing a second application, which is configured to communicate with the distributed blockchain network 106 to retrieve the transaction information sent as blocks of the blockchain 130. The application launched from the electronic communication or electronic computing device 108 of the authorized service provider, which in some instances act as a computing node of the distributed blockchain network 106, extracts the block or blocks 318 to 324, containing the coded transaction information. Once the transaction information is retrieved, the application performs the decryption and allows the authorized service personnel associated with the authorized financial service provider 110 to verify the unique ID and the unique PIN provided by the receiver to perform the secure instant cash transaction. Upon successful authentication, the authorized financial service provider 110 issues an amount equivalent to the amount sent by the sender. In some instance, the authorized financial service provider 110 charges a flat rate or transaction amount based service fee for each transaction. The receivers can receive instant cash in the desired currency of the receiver or a currency set by the sender or the authorized financial service provider 110.

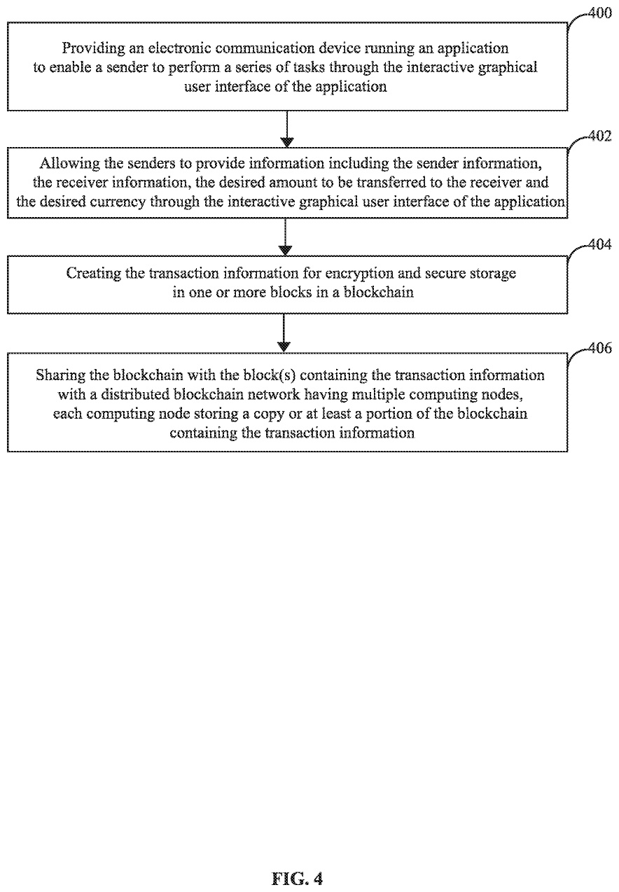

FIG. 4 illustrates a flowchart showing the steps associated with the present method for sending money utilizing the present application 200 for transferring money from the sender to a recipient using blockchain technology, according to a preferred embodiment of the present invention. The method starts with the first step of providing the electronic communication device 102 having a memory unit 116 for storing the instructions of the present application 200 and one or more processors 122 for processing the instructions of the application 200 to enable the sender to perform a series of tasks through the interactive graphical user interface of the application 200, as in block 400. In some instances, the present application 200 is a mobile application capable of being launched from the personal electronic communication device 102 such as smartphone or tablet of the sender. In some other instances, the present application 200 is a desktop or web application accessible using a web browser, which is accessible to the sender through the electronic communication devices 102 such as a computer, or a smartphone or tablet or any other device. Once the application 200 is launched from the electronic communication device 102 the senders can login to the application 200 using their unique user credentials. For first time users, the application 200 allows the users to register into the application 200 using a variety of information including the personal and financial information of the user and is allocated with unique login credentials. In some instances, the application 200 prompts the users to link their existing bank accounts, credit or debit cards, PayPal or other similar online sources to utilize the present application 200 as a digital wallet or an online financial account. This allows the users to add money into their personal financial account in the application 200 directly from their above said financial sources utilizing the interactive user interface of the application 200. In order to transfer money to a receiver, the senders are prompted to provide one or more information including the sender information, the receiver information, the desired amount to be transferred to the receiver and the desired currency through the interactive graphical user interface of the application 200, as in block 402. Once the above information is received, the application 200 creates the transaction information for encryption and secure storage in one or more blocks of a blockchain 130, as in bock 404. The transaction information transferred in form of the block(s) in the blockchain 130 includes the sender information including a name, address of the sender, and other relevant information of the sender, the receiver information including the unique identification information or unique ID of the receiver, an email address or any other alternate contact method of the receiver, an encrypted code corresponding to the unique PIN generated by the application and shared with the receiver via the email address or any other alternate contact method of the receiver for the particular secure transaction and an information related to the amount and the currency provided by the sender.

In some instances, the present application 200 allows the senders to provide the unique identification information of the receiver selected from a group consisting of a national ID, a government identifier information, an employment ID, a personal banking related information, an educational ID or any other kind of identification information unique to the receiver. The unique identification information of the receiver thus provided by the sender through the interactive graphical user interface of the application 200 is encrypted and stored in the block(s) of the blockchain 130 and is utilized in form of a personal identity verifier of the receiver during the instant cash transaction. Further, the present application 200 automatically verifies the email address of the receiver, provided by the sender prior to making the transaction, and sends the unique PIN generated by the application 200 for the particular transaction via the email. The application also generates a unique code corresponding to the unique PIN generated by the application 200 for the particular transaction and shared with the receiver via the email and includes the code in the transaction information, which is encrypted and later stored in the block(s) of the blockchain 130. The blockchain 130 with the block(s) containing the transaction information is then shared with the distributed blockchain network 106 having multiple computing nodes, each computing node storing a copy or at least a portion thereof of the blockchain 130 containing the transaction information, as in block 406. The block(s) containing the transaction information is shared with the distributed blockchain network 106 through the secure wireless communication channel or the network 104 enabling communication between the electronic communication device 102 and the computing nodes of the distributed blockchain network 106. In some instances, the electronic communication device 102 of the sender and the electronic computing device 108 of the authorized financial service provider 110 forms two computing nodes of the distributed blockchain network 106.

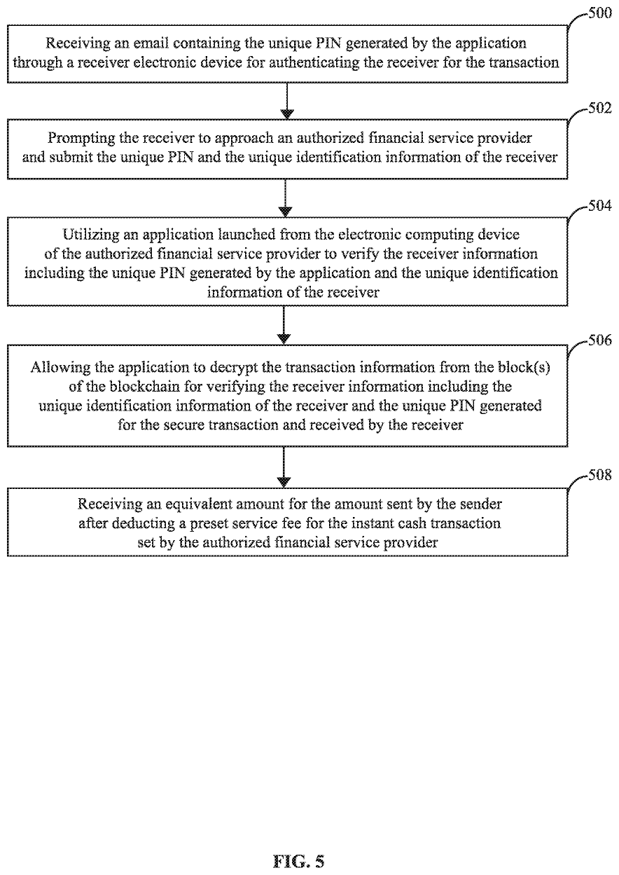

FIG. 5 illustrates a flowchart showing the steps associated with the present method for receiving the money, which is sent by the sender utilizing the present application 200 using blockchain technology, from the authorized financial service provider 110, according to a preferred embodiment of the present invention. The receiver receives the email containing the unique PIN generated by the application 200 for the particular transaction through a receiver electronic device such as the smartphone, tablet or a computer of the receiver, as in block 500. In some instances, the present system 100 utilizes multi-factor authentication methods for accessing the unique PIN generated for the particular transaction sent via the email of the receiver. A two-factor authentication method may include a phone number of the receiver in which he/she receives an authorization code, which he/she has to use for accessing the unique PIN generated for the particular transaction received in the email of the receiver. The receiver can approach the authorized financial service provider 110 associated with the present system 100 for transferring money using blockchain technology and submit the unique PIN and the unique identification information of the receiver for receiving the cash, as in block 502. The authorized financial service provider 110 verifies the receiver information including the unique PIN generated by the application and the unique identification information of the receiver utilizing an application launched from the electronic computing device 108 of the authorized financial service provider 110, as in block 504. The application running on the electronic computing device 108 of the authorized financial service provider 110 is selected from a mobile application or a web application configured to communicate with the distributed blockchain network 106. In some instances, the electronic computing device 108 of the authorized financial service provider 110 runs a web version of the mobile application 200 run by the electronic communication device 102 of the sender. In some instance, the electronic computing device 108 of the authorized financial service provider 110 forms a computing node of the distributed blockchain network 106 for retrieving the block(s) of the blockchain 106 containing the transaction information in an encrypted form. Thus as in block 506, the application running on the electronic computing device 108 of the authorized financial service provider 110 decrypts the transaction information from the block(s) of the blockchain 130 for verifying the receiver information including the unique identification information of the receiver and the unique PIN, which is generated by the application for the secure transaction, received by the receiver through email. Upon successful verification of the receiver, as in block 508, the receiver receives an equivalent amount of the amount sent by the sender after deducting a preset service fee for the instant cash transaction set by the authorized financial service provider 110. Thus the distributed nature of the encrypted transaction information in the blockchain through the computing nodes of the distributed blockchain network 106 makes the present system 100 and method a secure way for making instant cash transactions.

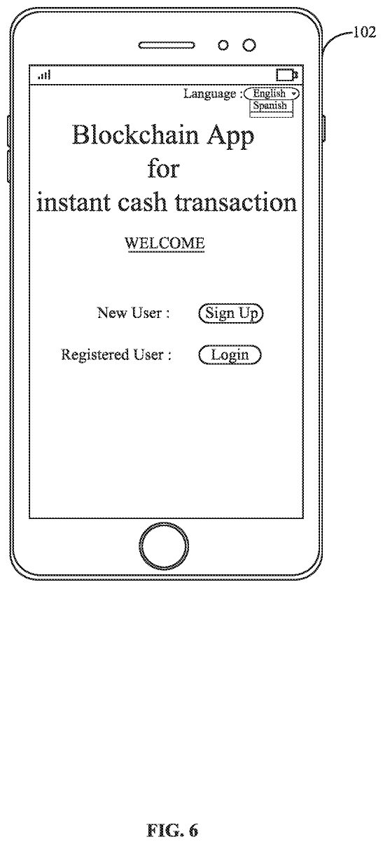

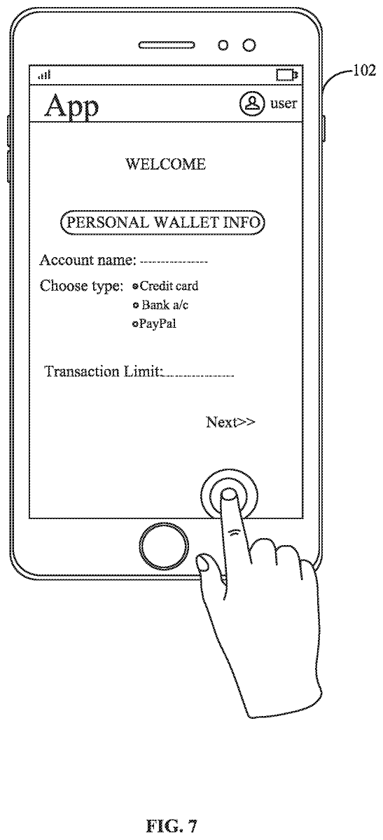

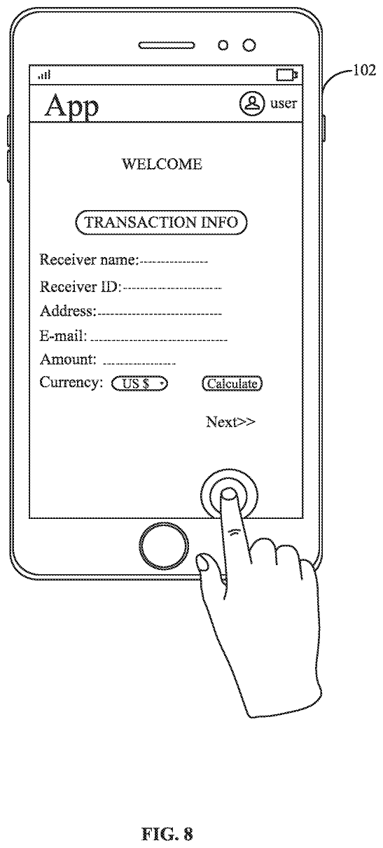

FIG. 6 is an exemplary user interface of the present application 200, running on the electronic communication device 102, for transferring money from a sender to a recipient using blockchain technology, according to an exemplary embodiment of the present invention. The users can launch the application 200 from their electronic communication devices 102, such as smartphone, tablets, etc. and are prompted to login to the application 200 using their unique user credentials. For first time users, the applications 200 allows the users to register into the application 200 using a variety of information including the personal and financial information of the user and are provided with unique login credentials. In addition, the application 200 allows the users to select a desired language through the interactive graphical user interface. In some instances, the application 200 prompts the users to link their existing bank accounts, credit or debit cards, PayPal or other similar online sources to utilize the present application 200 as a digital wallet or an online financial transaction account, as in FIG. 7. This allows the users to add money into their personal financial account in the application 200 directly from their above said financial sources utilizing the interactive user interface of the application 200. In order to transfer money to a receiver, the senders are prompted to provide one or more information including the sender information, the receiver information, the desired amount to be transferred to the receiver and the desired currency through the interactive graphical user interface of the application 200, as in FIG. 8. In some instances, the application 200 includes additional features, which would allow the users to check the present currency conversion rates and the service fee for each transaction prior to making one. Once all the information is received through the interactive user interface, the application 200 allows the users to send the money to the desired recipient. The application 200 encrypts the transaction information in the background and distributes as block(s) of the blockchain 130 through the distributed blockchain network 106 over the secure communication channel or the wireless network 104. The recipient receivers the unique PIN for the transaction through the email or other communication means mentioned by the sender, which he/she can submit to the authorized financial service provider 110. The authorized financial service provider 110 verifies the information including the unique PIN and the unique identification information or ID of the recipient utilizing an application running on their electronic computing device, which forms a computing node of the distributed blockchain network 106. The application decrypts the transaction information and verifies the unique PIN and the unique identification information or ID of the recipient and approves the instant cash transaction for valid claims.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, technological advances, etc., other methods of use arrangements, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

1. A computer-implemented system for transferring money from a sender to a receiver comprising:
an electronic communication device having at least one memory unit for storing a plurality of instructions of an application and at least one processor for processing the plurality of instructions of the application to perform a plurality of tasks including:
enabling the sender to add a desired amount in a desired currency utilizing an interactive graphical user interface of the application;
provide a plurality of receiver information including at least one contact information and at least one unique identification information of the receiver to perform a secure transaction;
encrypt and transfer a transaction information related to the secure transaction stored in form of at least one block of a blockchain;
a distributed blockchain network having a plurality of computing nodes, each computing node storing a copy or at least a portion thereof of the blockchain containing the transaction information related to the secure transaction performed by the sender;
a secure wireless communication channel enabling communication between the electronic communication device and the computing nodes of the distributed blockchain network for transferring the transaction information; and
an electronic computing device associated with an authorized financial service provider for verifying the receiver information including a unique PIN generated by the application, received through the contact information of the provided by the sender, for performing the secure transaction via the secure wireless communication channel;
wherein an application running on the electronic computing device associated with the authorized financial service provider communicates with the distributed blockchain network to retrieve and decrypt the at least one block containing the transaction information from the blockchain and verifies the unique identification information and the unique PIN submitted by the receiver for completing an instant cash transaction.

2. The computer-implemented system of claim 1, wherein the application running on the electronic communication device shares the unique PIN generated for the secure transaction through the at least one contact information of the receiver selected from an group consisting of an email, phone number, and other secure contacting means.

3. The computer-implemented system of claim 1, wherein the transaction information includes a plurality of sender information, the plurality of receiver information including the unique identification information of the receiver, an encrypted code corresponding to the unique PIN generated by the application for the secure transaction and an information related to the desired amount selected by the sender.

4. The computer-implemented system of claim 1, wherein the transaction information includes the unique identification information of the receiver selected from a group consisting of a national ID, a government identifier information, an employment ID, a personal banking related information, an educational ID or any other kind of identification information unique to the receiver, wherein the unique identification information, encrypted and stored in the at least one block of the blockchain, is utilized in form of a personal identity verifier of the receiver.

5. The computer-implemented system of claim 1, wherein the receiver receives an equivalent amount of the desired amount sent by the sender after deducting a preset service fee for the instant cash transaction upon successful authentication of the receiver using the application.

6. A computer assisted method for transferring money from a sender to a receiver comprising the steps of:
providing an electronic communication device having at least one memory unit for storing a plurality of instructions of an application and at least one processor for processing the plurality of instructions of the application to perform a plurality of tasks including:
enabling the sender to provide a plurality of information including a plurality of sender information, a plurality of receiver information and a desired amount in a desired currency through an interactive graphical user interface of the application;
encrypting a transaction information including the plurality of information received from the sender;
storing the transaction information in form of at least one block of a Blockchain;
transferring the transaction information using a distributed blockchain network having a plurality of computing nodes, each computing node storing a copy or at least a portion thereof of the blockchain containing the transaction information;
utilizing a secure wireless communication channel enabling communication between the electronic communication device and the computing nodes of the distributed blockchain network for transferring the transaction information;
receiving the receiver information including a unique PIN generated by the application, received through the at least one email address provided by the sender, using a receiver electronic device for performing a secure transaction via a secure wireless communication channel; and
verifying the receiver information including a unique PIN generated by the application and a unique identification information of the receiver utilizing an application launched from an electronic computing device of an authorized financial service provider to authorize an instant cash transaction to the receiver.

7. The method of claim 6, wherein the application running on the electronic communication device is selected from a mobile application or a web application.

8. The method of claim 6, wherein the transaction information transferred in form of the block in the blockchain includes:
the plurality of sender information including a name and an address of the Sender;
the plurality of receiver information including the unique identification information of the receiver, an encrypted code corresponding to the unique PIN generated by the application for the secure transaction; and
an information related to the desired amount and the desired currency set by the sender.

9. The method of claim 6, wherein the electronic computing device of the authorized financial service provider forms the at least one computing node of the distributed blockchain network for retrieving the at least one block of the blockchain containing the transaction information in an encrypted form.

10. The method of claim 6, wherein the application running on the electronic computing device of the authorized financial service provider decrypts the transaction information from the blockchain for verifying the receiver information including the unique identification information of the receiver and the unique PIN generated by the application for the secure transaction.

11. The method of claim 6, wherein the receiver receives an equivalent amount of the desired amount sent by the sender after deducting a preset service fee for the instant cash transaction upon successful authentication of the receiver by the authorized financial service provider.
